(19) United States
(12) Patent Application Publication
(10) Pub. No.: US 2007/0133859 A1
(43) Pub. Date: Jun. 14, 2007

(54) METHODS AND SYSTEMS FOR READING MAGNETIC INK CHARACTER RECOGNITION INFORMATION

(75) Inventors: Robert L. Babanats, Vestavia Hills, AL (US); William Weaver, Memphis, TN (US)

Correspondence Address: DARBY & DARBY P.C., P. O. BOX 5257, NEW YORK, NY, 10150-5257, US

(73) Assignee: Imaging Business Machines, LLC, Birmingham, AL (US)

(21) Appl. No.: 11/553,192

(22) Filed: Oct. 26, 2006

Related U.S. Application Data
(60) Provisional application No. 60/731,533, filed on Oct. 28, 2005.

(51) Int. Cl. G06K 9/00

(52) U.S. Cl. 382/139

(57) ABSTRACT

A system for recognizing magnetic ink characters includes at least one write head configured and arranged to scan over the magnetic ink characters while generating a modulated magnetic field to produce a magnetic response in the magnetic ink characters. The modulation of the magnetic field produces spatial modulation in the magnetic response. The system also includes at least one read head configured and arranged to scan over the magnetic ink characters after the write head and to detect the magnetic response. The system further includes a recognition module to receive the magnetic response from the read head(s) and recognize the magnetic ink characters thereby.

### CROSS-REFERENCE TO RELATED APPLICATIONS

This application claims the benefit under 35 USC 119(e) of U.S. Provisional Patent Application Ser. No. 60/731,533, filed on Oct. 28, 2005, which is herein incorporated by reference.

### FIELD

The present invention relates to methods and systems for the machine reading of printed information, particularly information printed as magnetic ink character recognition (MICR) characters or the like.

### BACKGROUND

Magnetic ink character recognition (MICR) characters are printed in magnetic ink and are useful for a variety of applications including for printing numbers, characters, and symbols on paper checks, other documents, and the like. These magnetic ink characters have a specialized style, or font, that allows them to be read visually for example, while also generating a unique waveform at a magnetic sensor when the ink is magnetized and the character is read left-to-right or right-to-left.

Often, the numbers, characters, and symbols are printed in a horizontal line on a paper check or other document. In a typical MICR reader, a permanent magnet magnetizes the ink followed by a single track magnetic read head that passes over each character, one at a time, in a left-to-right or right-to-left motion. In this manner, each character in a line of characters is read sequentially. As the read head passes over each character, a waveform is generated by the read head in response to the pattern of magnetic ink. This waveform is representative of the character. The design of each character in a set of MICR characters is selected so that it will generate a unique waveform. By analyzing the waveforms detected by the read head, each MICR character can thus be recognized.

The magnetic nature of MICR makes it possible to perform machine recognition of MICR characters in situations where visual or optical reading is not possible, such as in cases where the MICR characters have been overwritten, as can occur with paper checks.

### BRIEF SUMMARY

One embodiment is a system for recognizing magnetic ink characters. The system includes at least one write head configured and arranged to scan over the magnetic ink characters while generating a modulated magnetic field to produce a magnetic response in the magnetic ink characters. The modulation of the magnetic field produces spatial modulation in the magnetic response. The system also includes at least one read head configured and arranged to scan over the magnetic ink characters after the write head and to detect the magnetic response. The system further includes a recognition module to receive the magnetic response from the read head(s) and recognize the magnetic ink characters thereby.

Another embodiment is a method of recognizing a magnetic ink character. First, the magnetic ink character is scanned with at least one write head that generates a modulated magnetic field to produce a spatially modulated magnetic response in the magnetic ink character. The magnetic ink character is scanned with at least one multichannel read head that detects the spatially modulated magnetic response. Finally, the magnetic ink character is recognized based on the detected spatially modulated magnetic response. In at least some instances, more than one magnetic ink character can be scanned simultaneously by the write head(s) and then by the read head(s).

Yet another embodiment is a system for recognizing magnetic ink characters. The system includes at least one write head configured and arranged to scan over the magnetic ink characters while generating a magnetic field to produce a magnetic response in the magnetic ink characters. The system also includes a multichannel read head configured and arranged to scan over the magnetic ink characters after the write head and to detect the magnetic response to the magnetic field of the at least one write head. The write head and the multichannel read head are configured and arranged to scan over multiple magnetic ink characters from top-to-bottom or from bottom-to-top of the characters. In addition, the system includes a recognition module to receive the magnetic response from the multichannel read head and recognize the magnetic ink characters thereby.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic diagram of a magnetic ink character recognition (MICR) system, according to the invention;

FIG. 2 is a graph of amplitude versus time for one embodiment of a modulated magnetic field for use with the write head of the MICR system of FIG. 1;

FIG. 3 is a graph of amplitude versus time for a second embodiment of a modulated magnetic field for use with the write head of the MICR system of FIG. 1;

FIG. 4 is a graph of amplitude versus time for a third embodiment of a modulated magnetic field for use with the write head of the MICR system of FIG. 1;

FIGS. 5A, 6A, and 7A are schematic illustrations of magnetic ink recognition characters represented on a matrix produced by operation of the MICR system of FIG. 1;

FIGS. 5B, 6B, and 7B are schematic illustrations of a second matrix formed by processing of the characters of FIGS. 5A, 6A, and 7A, according to the invention; and

FIG. 8 illustrates a convention magnetic ink character recognition system that reads characters from left-to-right.

### DETAILED DESCRIPTION

The present invention is directed to the area of methods and systems for the machine reading of printed information, particularly information printed as magnetic ink character recognition (MICR) characters or the like.

In one embodiment, a device for recognizing and reading magnetic ink characters includes a magnetic write head and at least one multichannel magnetic read head. When a medium with magnetic ink characters is presented, the magnetic write head scans over the magnetic ink characters with a magnetic field that induces a magnetic response in the magnetic ink characters. The magnetic field is modulated as the magnetic write head scans over the characters to produce a response in the magnetic ink characters that is spatially modulated not only by the shape of the character but also as a result of the modulation of the magnetic field. Such a response can be referred to as a “spatially modulated response.” For example, the magnetic field of the write head can be modulated by an appropriate wave shape, such as a sine wave or triangle wave, or other wave shapes.

Reading is performed by a multichannel read head which can be, for example, a single multichannel read head or multiple multichannel or single channel read heads. The read heads are scanned over the magnetic ink characters after the write head to detect the magnetic response generated in the characters by the write head. The magnetic response, as detected by the read heads, is then provided to a recognition system that evaluates the magnetic response and determines which characters are represented by the response.

This device can be used to scan and recognize multiple characters (e.g., an entire, or partial, line of characters) simultaneously. For example, a line of characters can be scanned in “landscape” mode (e.g., simultaneously; top-to-bottom or bottom-to-top) instead of in “portrait” mode (e.g., sequentially; right-to-left or left-to-right.)

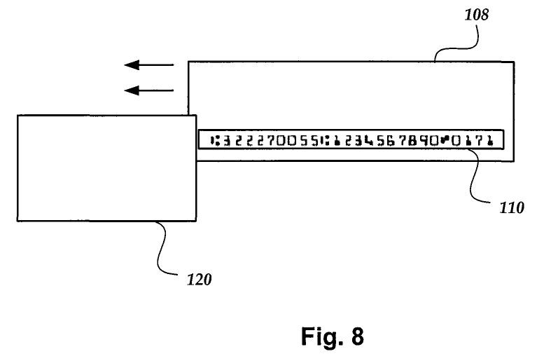

In contrast, conventional magnetic ink recognition devices operate in portrait mode and read each character sequentially, as illustrated in FIG. 8. These devices 120 receive a medium 108 with characters 110 and capture the characters sequentially from right-to-left or left-to-right. Because the devices of the present invention can read multiple characters simultaneously, an increase in overall reading speed can be achieved over conventional methods, in at least some embodiments or if desired.

The present MICR characters have been developed for the conventional type of character reading so that individual characters produce different responses when read right-to-left or left-to-right. The device described herein allows characters to be read from top-to-bottom or bottom-to-top. The use of a modulated magnetic field, as described herein, can facilitate accurate and reproducible recognition, including, in some embodiments, recognition at lower resolution, or at quicker speeds, than can be achieved without a modulated magnetic field.

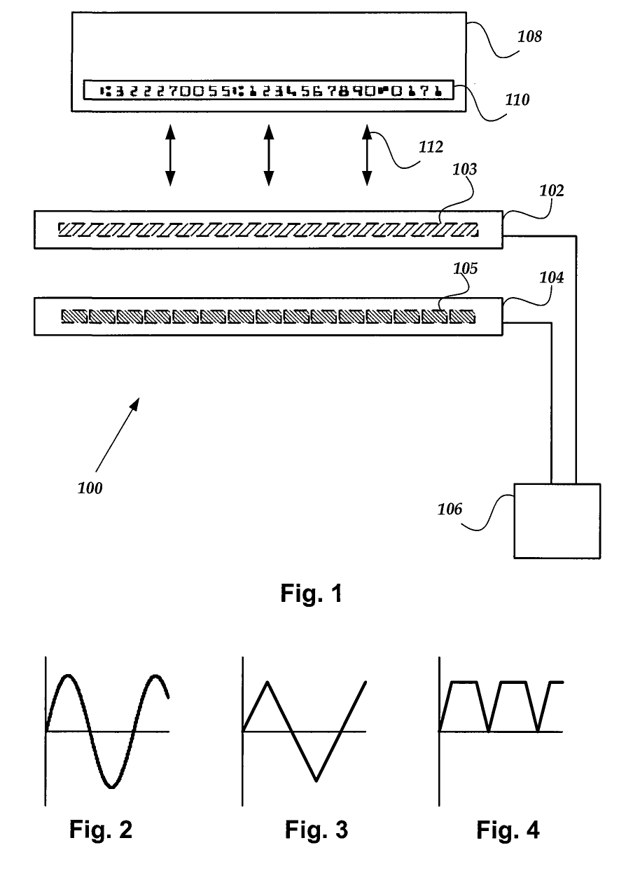

FIG. 1 schematically illustrates one embodiment of a device 100 for magnetic ink character recognition. The device includes a write assembly 102 that has at least one write head 103; a read assembly 104 that has at least one multichannel read head 105; and a control/recognition system 106. The device 100 also includes a transport mechanism (as represented by arrows 112) for scanning a medium 108 containing magnetic ink characters 110 past the write assembly 102 and read assembly 104. For example, the transport mechanism may transport the medium 108 past a stationary write assembly and read assembly or may move the write assembly and read assembly over a stationary medium. It will be recognized that there may also be embodiments in which the medium 108 and the write/read assemblies 102, 104 are all in motion. Any relative motion between the medium and write assembly/read assembly that allows the magnetic ink characters to be read will be referred to herein as “scanning” irregardless of whether one or the other of these items (or neither) is stationary.

The control/recognition system 106 can be one or more units that control operation of the write assembly 102, read assembly 104, and transport mechanism, as well as providing character recognition for the signals detected by the read head(s) 105. The control and recognition portions of the system 106 can be provided in individual units or as a single unit. The control portions of the system 106 that control individual items of the device can also be separate or combined. The functions of the control/recognition system 106 can be performed using hardware, software, or any combination thereof.

The control/recognition system 106 typically includes at least one processor, a memory unit (particularly for storing information about one or more predefined character sets), an output unit for providing the character recognition information to a user or other devices, and, optionally, an input unit for providing information to the device such as, for example, new character sets, the type or size of a document, the type or size of a line of characters, control commands, values for control variables (e.g., modulation frequency, scanning speed, etc.), and the like. The output unit can provide output on a display and/or to another device via wired or wireless connection or using a readable storage unit such as, for example, a diskette, a compact disc, or a memory stick. An input unit may receive input from another device using a wired or wireless connection or readable storage media and/or the device can receive input from a keyboard, mouse, touch screen, controller, or other input device.

The write assembly 102 typically includes at least one write head 103. The write head preferably extends over a length at least as long (and more preferably longer) than the combination of the one or more read heads. The allows the write head to magnetize characters along the entire length that will be subsequently read by the read head(s). The length of the write head(s) can vary with application. For example, to read a line of characters disposed width-wise on paper with an 8.5 inch (about 22 cm) width, the write head may have a length in the range of, for example, 6 to 10 inches (about 15 to 25 cm.) For A4 paper, the write head may have a length in the range of, for example, 15 to 25 cm. The write head may be smaller if the expected length of the character line is smaller than 6 inches or 15 cm. In some embodiments, the MICR device may be configured to only read a portion of the line of characters and the write head will be sized accordingly. In some of these embodiments, the transport mechanism may be configured to move the medium or write/read assemblies laterally after reading a first portion of a line of characters so that a second portion (and subsequent portions, if present) can be read. In one embodiment, the width of the write head is 9.75 inches.

The write head is typically an electromagnet that generates a magnetic field to create a magnetic response in the magnetic ink characters 110 when the write head scans over the characters 110 on the medium 108. The strength of the magnetic field at the magnetic ink character will depend, at least in part, on the distance to the write head, any material interposed between the write head and the magnetic field, and the amplitude of the magnetic field at the write head. The write head is disposed in the device 100 so that during scanning the write head is sufficiently proximate to the magnetic ink characters to produce a desired level of response to the magnetic field of the write head.

In at least some embodiments, the magnetic field generated by the write head is modulated so that the amplitude of the magnetic field varies over time. FIGS. 2-4 illustrate examples of modulated magnetic fields where the x-axis represents time and the y-axis represents the amplitude of the magnetic field. Preferably, the modulation is periodic with a predetermined period. FIG. 2 illustrates a sine wave modulation; FIG. 3 illustrates a triangular wave modulation; and FIG. 4 illustrates a trapezoidal wave modulation. It will be understood that other types of modulation can be used. In at least some embodiments, the modulation magnetic field has periodic excursions to zero or relatively low amplitude fields. The magnetic field and any modulation for the write head are typically controlled by the control/recognition system 106.

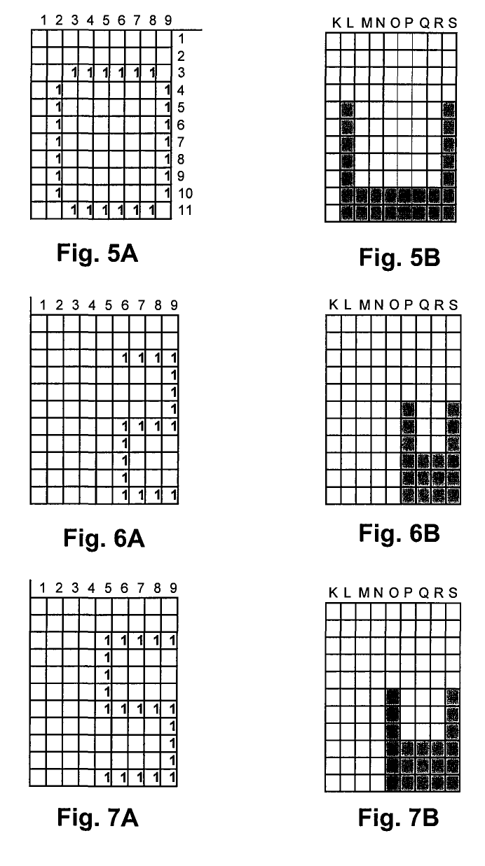

In at least some embodiments, the frequency of the modulation and the scanning speed of the device is such that a typical character block (e.g., the rectangular region into which a single character fits) (see FIGS. 5A, 6A, and 7A) is scanned over at least one full period of modulation and, more preferably, over at least two, or more full (or partial) periods of modulation, for example, over four, six, eight, ten, eleven, or twelve full or partial periods of modulation. Such an arrangement will then effectively divide the character block into, for example, two, four, six, seven, eight, ten, eleven, twelve, or more rows defined by the modulation of the magnetic field from the write head and the scanning speed. (See FIGS. 5A, 6A, and 7A.) Each row represents a separate area that is subjected to a magnetic field and separated from the preceding and succeeding rows by a region where the magnitude of the magnetic field from the write head was substantially smaller (preferably, at or near zero.)

Preferably, the maximum amplitude or flux density of the magnetic field is selected so that the magnetic field does not saturate the magnetic ink over at least 10% of a modulation period. More preferably, the maximum amplitude or flux density of the magnetic field is selected so that the magnetic field does not saturate the magnetic ink over at least 25%, 50%, 75%, 90%, or 100% of the modulation period. Saturation of the magnetic field over too much of the modulation period may make identification of the individual rows difficult because of little variation in the magnetic response of the magnetic ink. In some instances, however, it may be desirable to saturate the magnetic ink to achieve an accurately readable signal.

The read assembly 104 includes at least one multichannel read head 105 and, preferably, multiple read heads. For example, the read assembly may include 5, 10, 20, 25, 30, 40, 50, 80, 100, 120, 150, 200, 250, 300, 400, 500, 600, or more channels. The multichannel read head of the read assembly may include one multichannel read head or several multichannel or single channel read heads operating together. The read heads can be aligned in one or more rows orthogonal to the direction of travel (represented by arrows 112 in FIG. 1) of the medium 108 relative to the read assembly 104. This arrangement allows the read heads 105 to capture multiple characters simultaneously, if desired.

In at least some embodiments, multiple read heads are designated for each character block. The placement of the read heads defines columns in the character block, as illustrated, for example, in FIGS. 5A, 6A, and 7A. One read head reads each column. In one embodiment, read heads are provided in a row with about 0.013 inch (about 0.33 mm) centers. For some standard sized characters, this spacing corresponds to approximately nine read heads per character block, as illustrated, for example, in FIGS. 5A, 6A, and 7A.

The size of a character block for a given character set may be constant or it may be variable. In some character sets, each character is provided in a uniformly sized block irregardless of the width of the character. In other character sets, the size of the character block may vary with the size of the individual characters. For example, the character “1” may have a narrower block than the character “8”.

The number of rows and columns in the matrix formed for each character block can impact the ability to recognize characters and will determine, at least in part, the resolution of the MICR device. The number of rows and columns to achieve a particular level of recognition accuracy can depend on a variety of factors including, but not limited to, the character set, the printing accuracy, the sharpness of the characters, stroke width, and magnetic ink quality. The number of rows can be varied by changing, for example, the modulation frequency or the scanning speed. The number of columns can be varied by changing, for example, the size or spacing of the individual read heads.

The following Table 1 provides examples of write frequency (in Hz) and scanning speed in inches per second (IPS) for a character block having a height of 0.115 inches (about 2.9 mm) with the magnetic field of the write head modulated to produce 11 rows per character block. The width of the columns in these examples can be, for example, 0.13 inches (about 3.3 mm.)

TABLE 1

| Scanning Speed | Write Frequency |
|---|---|
| IPS (cm/s) | HZ |
| 24 (61) | 2295.652 |
| 30 (76) | 2869.565 |
| 36 (91) | 3443.478 |
| 45 (114) | 4304.348 |
| 63 (160) | 6026.087 |
| 84 (213) | 8034.783 |

The read assembly is generally spaced sufficiently far from the write head so that the modulated magnetic field from the write head will not generate false readings in the read head(s). In one embodiment, the write head is spaced apart from the read heads by at least about 2 inches (about 5 cm.) The distance between the read head(s) and the write head(s) can be made shorter if shielding materials are disposed between the two assemblies.

The read heads 105 read or detect the response of the magnetic ink characters to the modulated magnetic field produced by the write head 103. The spatially modulated magnetic response arising from the modulated magnetic field from the write head and the spacing of the individual read heads will typically divide each character block 200 into a matrix of individual elements 202, as illustrated, for example, in FIGS. 5A, 6A, and 7A. Generally, the read head will receive a magnetic response for each of the elements 202 that contains magnetic ink. The strength of the signal will depend, at least in part, on the amount of ink and the position of the ink within the element 202, as well as the strength of the magnetic field from the write head.

When the read head receives the spatially modulated signal, the signal is processed. In one embodiment, the signal is rectified and amplified. For example, the signal can be full wave rectified and then amplified using any conventional amplification technique. In one embodiment, the amplifier may be a logarithmic amplifier with a floating threshold. This can be particularly useful in instances where the density of magnetic material in the magnetic ink characters within a particular document or between documents can vary substantially. Variation in magnetic material can arise for a variety of factors such as, but not limited to, ink composition, printed ink density, character point size, stroke width (e.g., thickness of the lines in the character), voids in the ink coverage, and ink aging.

The response (including the lack of any signal) detected by the read head(s) 105 is provided to the control/recognition system 106 which then evaluates the response for each element of the matrix. In one embodiment, the system 106 determines for each matrix element whether the response detected for that element meets or exceeds a threshold value. Those matrix elements that meet or exceed the threshold value are categorized as containing magnetic ink and those that do not meet the threshold value are categorized as not containing magnetic ink. In FIGS. 5A, 6A, and 7A, matrix elements in the first category are labeled with “1” and other elements are left blank. The threshold level may be a fixed threshold or can be a variable threshold that can be scaled to address, for example, variation in magnetic ink density in the characters. As an illustration of one method of scaling a threshold, in one embodiment, each document may include a known character found in a standard position (for example, the first character in the upper left corner.) The recognition system can then utilize the readings from the known character to calibrate the threshold value for indicating presence of ink in a matrix element. In at least some instances, all calibration on the device will be done at the factory.

The control/recognition system 106 can evaluate the magnetic response detected by the read head(s) by a variety of different methods. In general, methods currently employed in optical character recognition or matrix matching can generally be used to recognize the characters from the processed signal. In one embodiment, a character block can be read by the read heads and processed to generate a matrix with elements categorized as containing magnetic ink or not. Optionally, the character block may be positioned by shifting all of the elements down one row until there is at least one “1” element in the bottom row, as well as shifting all the elements to the right until there is a “1” element in the far right column. The processed character block can then be compared on a pixel-by-pixel basis with predefined character blocks for each individual character (e.g., number, letter, or other symbol) in a predefined character set. If there is no exact match, a probable match can be determined based on the similarities between the processed character block and the predefined characters, if desired. There are, however, other, more efficient methods of character recognition.

FIGS. 5B, 6B, and 7B illustrate one step in another method of character recognition. The secondary matrices of FIGS. 5B, 6B, and 7B are formed by shifting down all the “1” elements in each vertical column of the primary matrices of FIGS. 5A, 6A, and 7A, respectively. This secondary matrix can then be used for character recognition. For example, the secondary matrix can be considered a “waveform” that can be compared to “waveforms” from the predefined characters of a character set. The amplitude (e.g., the number of 1's) in each column can be compared with secondary matrices for each predefined character in the character set for character recognition.

In some instances, there may be special rules that eliminate categories of characters. For example, the width of the measured character may eliminate from consideration those characters that are wider or narrower. (See, for example, FIGS. 5B, 6B, and 7B where “0” is wider than “5” which is, in turn, wider than “2”.) The maximum amplitude may also be used to eliminate groups of characters (e.g., the maximum amplitude of “0” is higher than the maximum amplitude for “2” or “5”.)

One or more columns (preferably, two or three or more columns) with zero amplitude in the secondary matrix may also be used to indicate separation between characters. This may be particularly useful for character sets with character blocks having variable width or to initially determine the beginning of the first or second block to establish the block pattern.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A system for recognizing magnetic ink characters, the system comprising:
at least one write head configured and arranged to scan over the magnetic ink characters while generating a modulated magnetic field to produce a magnetic response in the magnetic ink characters, wherein the modulation of the magnetic field produces spatial modulation in the magnetic response;
at least one read head configured and arranged to scan over the magnetic ink characters after the write head and to detect the magnetic response; and
a recognition module to receive the magnetic response from the at least one read head and recognize the magnetic ink characters thereby.

2. The system of claim 1, wherein the at least one read head comprises a plurality of read heads.

3. The system of claim 2, wherein the plurality of read heads are disposed in a linear arrangement orthogonal to a scanning direction of the magnetic ink characters.

4. The system of claim 2, wherein the write head and plurality of read heads are configured and arranged for scanning a plurality of magnetic ink characters simultaneously.

5. The system of claim 2, wherein the plurality of read heads are configured and arranged so that each character is scanned using at least two of the read heads.

6. The system of claim 1, wherein the modulated magnetic field comprises a periodic modulation.

7. The system of claim 6, wherein the modulated magnetic field comprises periodic excursions to substantially zero magnetic field.

8. The system of claim 6, wherein the periodic modulation comprises a sine wave or triangle wave modulation.

9. The system of claim 1, wherein the at least one write head and the at least one read head are configured and arranged to scan the magnetic ink characters from top-to-bottom or bottom-to-top.

10. The system of claim 1, further comprising a transport mechanism which transports the magnetic ink characters past the write head and the read head.

11. A method of recognizing a magnetic ink character, the method comprising:
scanning the magnetic ink character with at least one write head that generates a modulated magnetic field to produce a spatially modulated magnetic response in the magnetic ink character;
scanning the magnetic ink character with at least one multichannel read head that detects the spatially modulated magnetic response; and
recognizing the magnetic ink character based on the detected spatially modulated magnetic response.

12. The method of claim 11, wherein scanning the magnetic ink character with at least one write head and scanning the magnetic ink character with at least one read head comprises forming a matrix with matrix elements defined by positions of the at least one read head and the spatial modulation of the spatially modulated magnetic response.

13. The method of claim 12, wherein recognizing the magnetic ink character comprises recognizing the magnetic ink character by comparing, on a matrix element-by-matrix element basis, the spatially modulated magnetic response for a plurality of the matrix elements with expected magnetic responses for a set of predefined characters.

14. The method of claim 12, wherein recognizing the magnetic ink character comprises forming a secondary matrix by shifting down elements producing a magnetic response of at least a threshold value and comparing the secondary matrix with patterns expected for a set of predefined characters.

15. The method of claim 11, wherein scanning the magnetic ink character with at least one write head and scanning the magnetic ink character with at least one read head comprises simultaneously scanning a plurality of magnetic ink characters with the at least one write head and simultaneously scanning a plurality of magnetic ink characters with the at least one read head

16. The method of claim 11, wherein scanning the magnetic ink character with at least one write head that generates a modulated magnetic field comprises modulating the magnetic field with a sine wave.

17. The method of claim 11, wherein scanning the magnetic ink character with at least one write head and scanning the magnetic ink character with at least one read head comprises scanning the magnetic ink characters with the at least one write head and the at least one read head from top-to-bottom or bottom-to-top of the characters.

18. A system for recognizing magnetic ink characters, the system comprising:
at least one write head configured and arranged to scan over the magnetic ink characters while generating a magnetic field to produce a magnetic response in the magnetic ink characters;
a multichannel read head configured and arranged to scan over the magnetic ink characters after the write head and to detect the magnetic response to the magnetic field of the at least one write head, wherein the at least one write head and the multichannel read head are configured and arranged to scan over multiple magnetic ink characters from top-to-bottom or from bottom-to-top of the characters; and
a recognition module to receive the magnetic response from the multichannel read head and recognize the magnetic ink characters thereby.

19. The system of claim 18, further comprising a transport mechanism which transports the magnetic ink characters past the write head and the read head.

20. The system of claim 18, wherein the multichannel read heads comprises at least 20 channels.
